(19) United States
(12) Patent Application Publication
(10) Pub. No.: US 2018/0240441 A1
(43) Pub. Date: Aug. 23, 2018

(54) STRING INSTRUMENT

(71) Applicant: YAMAHA CORPORATION, Hamamatsu-shi (JP)

(72) Inventors: Kenta ISHIZAKA, Hamamatsu-shi (JP); Ryo SHINODA, Hamamatsu-shi (JP)

(21) Appl. No.: 15/937,056

(22) Filed: Mar. 27, 2018

Related U.S. Application Data
(63) Continuation of application No. PCT/JP2016/067593, filed on Jun. 13, 2016.

(30) Foreign Application Priority Data
Sep. 30, 2015 (JP) 2015-194123

(51) Int. Cl. G10D 3/00; G10D 1/08

(52) U.S. Cl. CPC G10D 3/00; G10D 1/08

(57) ABSTRACT

A string instrument such as an electric guitar is provided involving technologies that enable deterioration in a musical performance to be reduced and also enable a sound quality to be improved. A string instrument according to the present invention includes a weight fixed at one or more positions in a head. The one or more positions preferably each correspond to a position of an antinode of vibration of the head in response to vibration of strings. The weight is preferably embedded in the head. The weight preferably has a block shape.

### TECHNICAL FIELD

The present invention relates to a string instrument.

### BACKGROUND ART

When an electric guitar as one of string instruments is played by picking strings, a main body of the electric guitar vibrates in response to the vibrations of the strings. The vibrations of the main body of the electric guitar in turn affect the vibrations of the strings, and the resultant vibrations affect the sound quality of emitted sounds produced through being detected by pickups.

### PRIOR ART DOCUMENTS

### Patent Documents

Nonpatent Document 1: “FATFINGER™ GUITAR”, (online), FENDER, (Retrieved, Sep. 16 2015), Internet <URL: http://intel.fender.com/en-JP/accessories/miscellaneous/fatfinger-guitar-nickel/>

### SUMMARY OF THE INVENTION

### Problems to be Solved by the Invention

Nonpatent Document 1 discloses a plate-like weight which is curved in a U-shape. This weight is attached to a head of an electric guitar by clamping a portion of the head on the inner sides of the U-shape. Nonpatent Document 1 describes that, when a player plays the electric guitar with this weight attached to a favored position in the head, the state of the vibrations of the main body of the electric guitar is altered and the sound quality of performed sounds (specifically, sustain) is improved, as compared to a normal electric guitar without the weight.

However, the degree of alteration in the state of the vibration of the main body of the electric guitar varies depending on positions where the weight is attached. The position where the weight of Nonpatent Document 1 is attached varies depending on each player. Therefore, in Nonpatent Document 1, proper alteration in the state of the vibration of the main body of the electric guitar may fail depending on a manner in which the weight is attached, whereby an effect of improving the sound quality of performed sounds may not be obtained. Furthermore, since the weight of Nonpatent Document 1 is attached by clamping a portion of the head of the electric guitar on the inner sides of the U-shape, if a player, for example, touches the weight during a performance, the weight may be moved or detached from the main body of the electric guitar, rather leading to deterioration in playing performance.

In addition, the weight of Nonpatent Document 1 is as heavy as about 100 g. Since a player of an electric guitar often stands while playing, the head having an additional weight of 100 g may impose a burden on the player. Furthermore, when the head has an additional weight of 100 g, the player tends to play with the head of the electric guitar down, as compared to the case without such a weight, whereby a performance quality may be deteriorated.

The present invention was made in view of such circumstances and has an objective of providing a string instrument such as an electric guitar involving technologies that enable deterioration in a musical performance to be reduced and also enable a sound quality to be improved.

### Means for Solving the Problems

According to an aspect of the present invention, a string instrument comprises a weight fixed at one or more positions in a head.

According to the string instrument of the aspect of the present invention, since the weight is fixed at one or more positions in the head, the position of the weight is prevented from moving. Furthermore, when the one or more positions in the head are set to correspond to positions of the antinode of vibration of the head in response to vibration of strings, due to fixing the weight at the positions of the antinode of vibration of the head, reliable variation of the state of vibrations of the main body of the string instrument is enabled without needing such a heavy weight to be fixed as in Nonpatent Document 1, whereby reliable variation of the sound quality of performed sounds is enabled.

### BRIEF DESCRIPTION OF THE DRAWINGS

FIG. 1 is a front view showing a structure of a head 10 of a guitar 1 according to an embodiment of the present invention;

FIG. 2 is a cross sectional view of the head 10 along the line A-A′;

FIG. 3 is a front view showing a structure of a head 10 of a guitar 1′ which is different from the guitar 1 of FIG. 1;

FIG. 4 is a cross sectional view of the head 10 along the line B-B′; and

FIG. 5 is a graph showing frequency characteristics of vibrations of both a main body of the guitar 1 of FIG. 1 and a main body of a normal guitar to which a weight 40 is not attached.

### DESCRIPTION OF EMBODIMENTS

Hereinafter, an embodiment of the present invention will be described with reference to the drawings.

### Embodiment

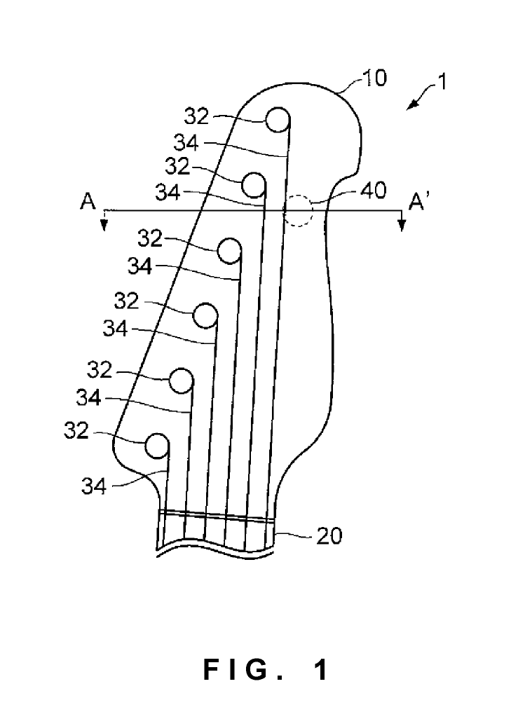

FIG. 1 is a front view showing a structure of a head 10 of an electric guitar 1 (hereinafter, may be merely referred to as guitar) according to an embodiment of the present invention. The head 10 includes six tuning pegs 32 (may be also referred to as “machine head”). In FIG. 1, only peghead portions of the tuning pegs 32 are illustrated. The tuning pegs 32 are provided in series close to the left side (the low-pitched string end) of the head 10 in a front view of the head 10. Strings 34 are each wound at one of approximate ends around the tuning pegs 32. The other ends of the strings 34 are each held by a body (not illustrated) so that the strings 34 are stringed along a neck 20. Therefore, the head 10 serves to hold the one end of each string 34.

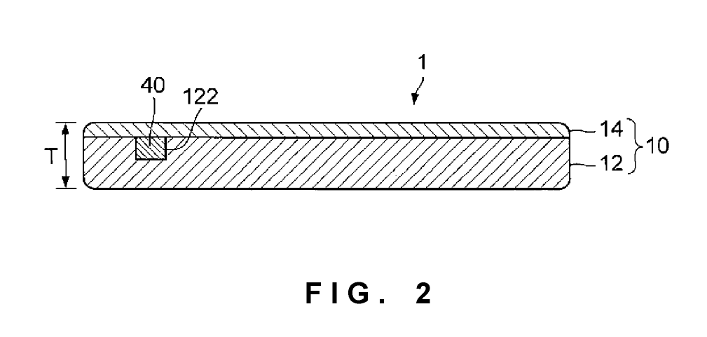

The head 10 has a weight 40 fixed therein (In FIG. 1, the weight 40 is fixed at one position in the head 10). More specifically, the weight 40 is embedded in the head 10. FIG. 2 is a cross sectional view of the head 10 along the line A-A′. As shown in FIG. 2, the head 10 has a plate-like shape having a predetermined thickness T, and has a structure in which a top plate 14 is being attached to a headstock 12. The weight 40 is a metallic member having a block shape. In the examples shown in FIGS. 1 and 2, the weight 40 has a cylindrical shape having a height less than the thickness T of the head 10. More specifically, the weight 40 is provided so that the axis thereof is in parallel with the thickness direction of the head 10, and the length of the axis is shorter than the thickness T of the head 10. A side of the headstock 12 provided with the top plate 14 includes a hole 122 having a size almost equivalent to that of the weight 40, and the weight 40 is accommodated in the hole 122. The weight 40 is accommodated in the hole 122 in such a manner that the rotation symmetry axis of the weight 40 runs perpendicularly to the board face of the head 10. The weight 40 is covered by the top plate 14, and thus is not exposed on the front face of the head 10. More specifically, the top face of the weight 40 is flush with the front face of the headstock 12, and the top plate 14 is provided so as to abut the top face of the weight 40 and the front face of the headstock 12. The diameter of the weight 40 is smaller than the width of the head 10 in the cross section along the line A-A′. For example, the diameter of the weight 40 is about 1 cm. The projection cross-sectional area of the weight 40 to the front view of the head 10 is sufficiently small with respect to the front-view area of the head 10.

The head 10 vibrates in response to vibration of each string 34. The vibration of the head 10 is expressed by superimposition of multiple vibration modes. In each vibration mode, a position of the antinode of vibration has a higher vibration level than those of other positions.

The weight 40 is embedded at a predetermined position in the head 10, specifically, at a position where the vibration level is higher than those of another positions of the head. Thus, the position where the weight 40 is fixed corresponds to a position of the antinode of vibration of the head 10 in response to the vibration of the strings 34. Such a position having a higher vibration level corresponds to the position of the antinode of vibration and the vicinity thereof (hereinafter, may be merely referred to as antinode of vibration). In other words, the “antinode of vibration” as referred to herein means a position of the antinode of vibration and the vicinity thereof, which may varies depending on the vibration mode. Therefore, the weight 40 is embedded at a position of the antinode in a vibration mode which produces sounds having a sound quality that is desired to be improved. The position of the weight 40 is preferably a position of the antinode in a vibration mode of flexural vibration or torsional vibration of the head 10. Furthermore, the position of the weight 40 is more preferably a position of the antinode in the primary mode of flexural vibration or torsional vibration of the head 10. In addition, such a vibration mode also varies depending on the shape and size of the head. Therefore, the position where the weight 40 is to be embedded is determined by the measurement and/or simulation of the vibration, taking into account the vibration modes, the shape and size of the head, etc., for each head type. In the example shown in FIG. 1, the weight 40 is embedded in the vicinity of the tuning peg 32 holding the second string (the tuning peg 32 located at the second highest position from the top of FIG. 1). However, this is merely an example of a position having a higher vibration level, and thus the position where the weight 40 is to be embedded is not limited to this position.

In the example shown in FIG. 1, a single weight 40 is embedded in the head 10, but the number of the weight 40 embedded in the head 10 is not limited thereto. The guitar 1 may have holes 122 for embedding the weight 40 at a plurality of positions in the head 10, and thus the weights 40 may be each embedded in the holes 122. It is expected that there may be a plurality of positions each having the abovementioned higher vibration level. In such a case, the holes 122 may be provided at the positions each having a higher vibration level, and the weight 40 may be embedded in each of the holes 122. Furthermore, the weight 40 may be embedded at all the positions having the higher vibration level, or alternatively, the weight 40 may be embedded at one or more positions decided by a designer (provider) of the guitar 1 among the positions having the higher vibration level.

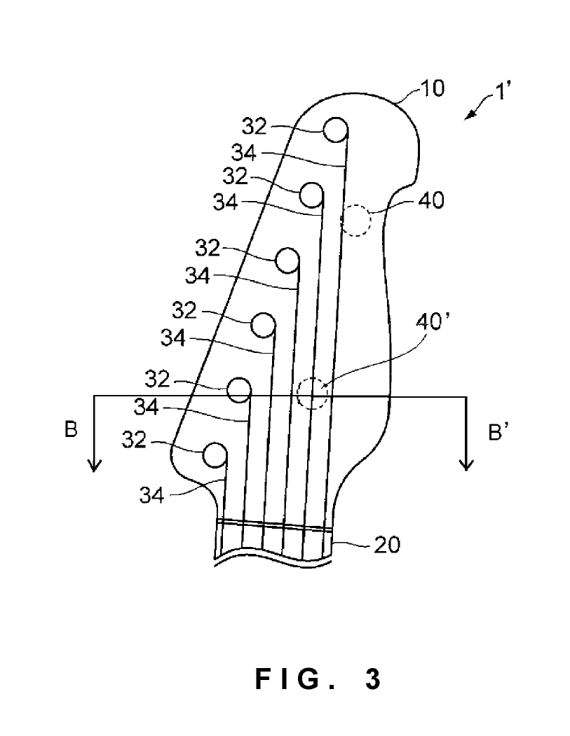

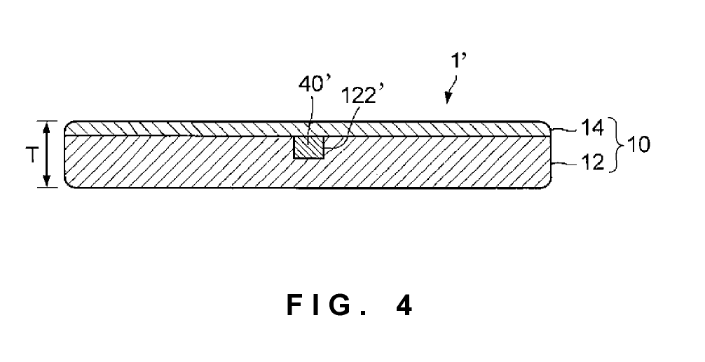

FIGS. 3 and 4 show a guitar 1′ having a plurality of weights 40 embedded in the head 10. In FIG. 3, in addition to the weight 40 embedded at a similar position to that of FIG. 1, a weight 40′ is further embedded at a position of the antinode of vibration of the head 10 which is different from that of the weight 40. Specifically, the weight 40′ is formed to have a similar shape with a similar material to those of the weight 40 of FIG. 1. Furthermore, a side of the headstock 12 which is in contact with the top plate 14 includes a hole 122′ having a size almost equivalent to that of the weight 40′ as shown in FIG. 4, as well as the hole 122 having a size almost equivalent to that of the weight 40, and the weights 40 and 40′ are accommodated in the holes 122 and 122′, respectively. It is to be noted that, although FIGS. 3 and 4 illustrate the case in which the two weights 40 and 40′ are formed to have a similar shape with a similar material to each other, the shape and the material of the two weights 40 and 40′ may differ from each other. Furthermore, FIGS. 3 and 4 illustrate merely an example for having the two weights 40 and 40′ embedded, and thus the positions for having the weights 40 and 40′ embedded are not limited to those shown in FIGS. 3 and 4.

The weights 40 and 40′ have a weight of 5 to 50 g each, and typically about 10 g. When the weights 40 and 40′ are embedded at a plurality of positions in the head 10, it is preferred that the total weight of the weights 40 and 40′ is less than 100 g, and more preferably no greater than 50 g.

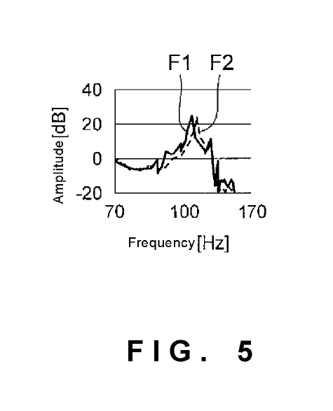

A solid line F1 in FIG. 5 shows a frequency characteristic of the vibration of the main body of the guitar 1 having the weight 40 embedded in the head 10 according to the present embodiment shown in FIG. 1. Also, a dash line F2 in FIG. 5 shows a frequency characteristic of the vibration of the main body of a normal guitar that may be provided by excluding the weight 40 from the head 10 of FIG. 1. As shown in FIG. 5, the peak around 100 Hz of the solid line F1 has shifted toward the low frequency side, as compared to the peak around 100 Hz of the dash line F2. In addition, the peak height around 100 Hz of the solid line F1 is approximately equivalent to the peak height around 100 Hz of the dash line F2. Accordingly, in the guitar 1 having the weight 40 embedded in the head 10 at a position where the vibration level is higher than those of another positions in the head 10, the frequency characteristic of the vibration of the main body of the guitar 1 has altered with respect to the frequency characteristic of the vibration of the main body of the normal guitar to which the weight 40 has not been attached. This result coincides with the phenomenon in which a frequency of vibration of a vibrating substance is smaller as the substance is heavier, suggesting a result as intended for the design. Therefore, the sound quality of performed sounds of the guitar 1 is improved through a change in sound quality of performed sounds of the normal guitar to which the weight 40 has not been attached.

As described in the foregoing, the guitars 1 and 1′ according to the present embodiment have the weights 40 and 40′ embedded at the positions of the antinodes of vibration of the head 10 in response to the vibration of the strings 34. Therefore, the positions of the weights 40 and 40′ are prevented from moving. Accordingly, alterations of the states of vibration of the main bodies of the guitars 1 and 1′ with respect to that of a normal guitar are enabled, without being influenced by a player's mode of use, whereby the improvement of the sound quality of performed sounds is enabled. Furthermore, typically, only a designer (provider) of the guitar 1 can know positions of the antinodes of vibration of the head 10. Due to precisely fixing the weights 40 and 40′ at each position of the antinodes of vibration of the head 10 of the guitars 1 and 1′, a proper improvement of the sound quality of performed sounds is enabled. Moreover, precisely fixing the weights 40 and 40′ at a position of the antinode of vibration of the head 10 of the guitars 1 and 1′ enables the states of vibration of the main bodies of the guitars 1 and 1′ to be appropriately altered without needing an increase in weight as disclosed in Nonpatent Document 1 for the weights 40 and 40′. Specifically, the weight of Nonpatent Document 1 is as heavy as about 100 g, whereas the weights 40 and 40′ of the guitars 1 and 1′ are as light as about 10 g. Therefore, the guitars 1 and 1′ are less likely to impose a burden on a player, and the player is less likely to play with the head of the electric guitar down, as compared to the guitar of Nonpatent Document 1 to which the weight is attached. Accordingly, the improvement of the sound quality of performed sounds is enabled without leading to deterioration in the playing performance.

Furthermore, in the guitars 1 and 1′, the sizes of the weights 40 and 40′ are sufficiently small with respect to the size of the head 10, respectively, and the rotation symmetry axes of the weights 40 and 40′ each having a short cylindrical shape run perpendicularly to the board face of the head 10, respectively. Therefore, the weights 40 and 40′ in the guitars 1 and 1′ can be regarded as point masses with respect to the head 10, and thus, the weights 40 and 40′ scarcely affect the rigidity of the entire head 10, whereby the sound quality of performed sounds is less likely to be deteriorated. Whereas, in cases where, for example, a long rod-like weight is embedded in the head in such a manner that the longitudinal direction of the weight runs almost in parallel to the board face of the head, or a plate-like weight is embedded in the head in such a manner that the plate face is almost in parallel to the board face of the head, the rigidity of the entire head may be changed, as compared to the case in which the weight is embedded in such a manner that the rotation symmetry axis runs perpendicularly to the board face of the head. The change in the rigidity of the entire head may lead to the deterioration of the sound quality of performed sounds. Therefore, the weight 40 preferably has a short cylindrical shape, a spherical shape, or a block shape such as a cubic shape, rather than a rod-like shape or a plate-like shape.

Furthermore, since the weights 40 and 40′ are embedded in the head 10 of the guitars 1 and 1′, the weights 40 and 40′ are provided at positions close to the center of vibration, as compared to the weight of Nonpatent Document 1 which is attached by clamping the head. Therefore, the weights 40 and 40′ can be regarded as point masses in the head 10, and thus the guitars 1 and 1′ enable the state of vibration of the main body of the guitar 1 to be precisely controlled, as compared to the guitar of Nonpatent Document 1 to which the weight is attached.

Furthermore, since the weights 40 and 40′ are embedded in the head 10 of the guitars 1 and 1′, a player will not touch the weight 40 or 40′. Therefore, according to the guitars 1 and 1′, a performance is not disturbed, or storage of the guitars 1 and 1′ is not hindered.

Furthermore, since the weights 40 and 40′ are not being exposed onto the front face of the head 10 of the guitars 1 and 1′, the appearance quality of the guitars 1 and 1′ is not deteriorated.

### Other Embodiments

Although an embodiment of the present invention is described above, other embodiments of the present invention still can be contemplated. Examples of such other embodiments are as follows.

(1) In the aforementioned embodiment, the weights 40 and 40′ of the guitars 1 and 1′ are embedded in the head 10 by being accommodated in the holes 122 of the head 10 and being covered by the top plate 14. However, a specific mode of having the weights 40 and 40′ embedded in the head 10 is not limited to such an embodiment. Without taking the appearance quality into consideration, the weights 40 and 40′ may be exposed onto the front face of the head 10 or may be exposed outward from the front face of the head 10 while being embedded in the head 10. Furthermore, the weights 40 and 40′ may not be embedded in the head 10, and may be fixed at one or more positions at least in/on the head 10. For example, the weights 40 and 40′ may be fixed by an adhesive at one or more positions on the front face of the head 10, since, as long as the weight is fixed, the improvement of the sound quality of performed sounds is enabled without being influenced by a player's mode of use.

(2) The shapes of the weights 40 and 40′ are not limited to the short cylindrical shape, and may be any shape as long as the shapes are less likely to affect the rigidity of the head 10. For example, the shapes of the weights 40 and 40′ may be spherical, rectangular solid, or cubic.

(3) In the aforementioned embodiment, the weights 40 and 40′ are embedded in the head 10 of the electric guitar. However, the embodiment is not limited to that of the electric guitar, and the weight may be embedded in a head of an electric bass. In other words, the technical feature of the aforementioned embodiment can be added to any string instrument having a head holding one ends of strings. Particularly, the technical feature of the aforementioned embodiment is preferably added to a string instrument having a solid body such as an electric guitar, since vibration of the main body of the string instrument greatly affect the head, according to such a string instrument having a solid body. Alternatively, the technical feature of the aforementioned embodiment can be also added to a string instrument having a hollow body such as an acoustic guitar. However, in such a string instrument having a hollow body, the advantage resulting from an effect of the technical feature of the aforementioned embodiment is less likely to be given, since the resonance in the body rather than vibration of the head is likely to greatly affect the sound quality of emitted sounds, according to such a string instrument having a hollow body.

### EXPLANATION OF THE REFERENCE SYMBOLS

1, 1′ Guitar
10 Head
12 Headstock
14 Top plate
20 Neck
32 Tuning peg
34 String
40, 40′ Weight
122, 122′ Hole

1. A string instrument comprising a weight fixed at one or more positions in a head.

2. The string instrument according to claim 1, wherein the one or more positions each correspond to a position of an antinode of vibration of the head in response to vibration of strings.

3. The string instrument according to claim 1, wherein the weight is embedded in the head.

4. The string instrument according to claim 1, wherein the weight has a block shape.

5. A string instrument comprising a head provided with at least one hole for embedding a weight at one or more positions in the head.
